(19) United States
(12) Patent Application Publication
(10) Pub. No.: US 2004/0031333 A1
(43) Pub. Date: Feb. 19, 2004

(54) Stirrer and condenser assembly for vessel array and method of use

(76) Inventor: Charles Amick Buckner III, Durham, NC (US)

Correspondence Address: DAVID J LEVY, CORPORATE INTELLECTUAL PROPERTY, GLAXOSMITHKLINE, FIVE MOORE DR., PO BOX 13398, RESEARCH TRIANGLE PARK, NC, 27709-3398, US

(21) Appl. No.: 10/332,943

(22) PCT Filed: Aug. 21, 2001
(86) PCT No.: PCT/US01/26134

(51) Int. Cl. G01N 1/00

(52) U.S. Cl. 73/863

(57) ABSTRACT

A condenser unit for use with a sample preparation device comprises and inner tube, a hollow outer sleeve, and a fluid conduit. The outer sleeve is coaxially disposed around the inner tube to define a condenser body. The fluid conduit is interposed between the inner tube and the outer sleeve. A first portion of the fluid conduit extends along an axial length of the condenser body and a second portion of the fluid conduit extends along a circumferential length of the condenser body. A stirrer assembly for stiring a substance in a container enables a quantity of the substance to be dispensed into and withdrawn from the container during a stirring operation. The stirrer assembly comprises a holow stir rod, a hollow agitator element, and a fluid sampling instrument. The stir rod and agitator element cooperatively define a stirrer assembly interior, such that the fluid sampling instrument can be movably disposed therein. The condenser unit and stirrer assembly can be integrally combined to provide a condenser/stirrer device.

### TECHNICAL FIELD

The present invention is generally directed to the preparation of sample solutions in vessels. Specifically, the present invention is directed to the stirring of such solutions and the prevention of loss of heated quantities of solution from such vessels through evaporation.

### BACKGROUND ART

As part of many drug development processes, an array of test tubes or other such vessels are commonly placed in a heater unit generally consisting of a block of metal with rows and columns of holes to receive the test tubes. The heater unit is often provided as one of many modules integrated in a workstation, wherein each module performs a specific function dictated by the particular development process.

As an example, FIG. 1 illustrates a conventional liquid sample preparation workstation generally designated 10. Workstation 10 typically includes a frame 12, a motor-driven robotic liquid handling module generally designated 20 equipped with a sampling needle 22, a dilution module generally designated 30, a heater unit generally designated 40, and a vessel rack assembly generally designated 50. Liquid handling module 20 includes a horizontal arm 24 movable along a lateral track 12A in frame 12 and a vertical arm 26 movable along a lateral track (not shown) in horizontal arm 24. Sampling needle 22 is mounted in a vertical track (not shown) of vertical arm 26. Stepper motors (not shown) are typically provided to power the movement of each relevant component of liquid handling module 20 along its associated track. As a result, sampling needle 22 is movable along three axes to perform operations at various locations of workstation 10.

Dilution module 30 is of the syringe pump type, and hence includes a syringe 32 and a valve 34. Dilution module 30 operates to transfer a diluting medium such as solvent from a solvent reservoir 35 over transfer lines 37A and 37B to sampling needle 22. Heater unit 40 includes a rack portion 42 and a lower enclosed portion 44 located behind the front of heater unit 40. Rack portion 42 is essentially a heat conductive metal plate with an array of wells adapted to support heater vessels 45, such that heater vessels 45 extend into enclosed portion 44 and are heated by a heating device contained therein. Enclosed portion 44 can also contain magnetic drives situated under each well. When activated, the magnetic drives couple with individual magnetic agitation elements dropped into each heater vessel 44 to stir the media contained in heater vessels 44.

Heater vessels 45 are used to contain masses of sample drugs, chemicals, compounds and the like. A heater control device 46 is mounted in front of enclosed portion 44 to enable programming of the heating profile for the quantities of sample solutions contained in heater vessels 45, and also to activate the magnetic drives. Vessel rack assembly 50 includes a number of rack mounts 52 for supporting vessel racks 54 of various types. Vessel racks 54 are in turn provided to accommodate arrays of vessels of various sizes and design, such as test tubes 56 and 57 and bottles 59.

In one general application of workstation 10, liquid handling module 20 moves into a position over heater unit 40, and sampling needle 22 is lowered such that its tip 22A pierces the septum of each heater vessel 45 to dispense a metered quantity of solvent therein. Once the diluted liquid samples are heated to a desired temperature, sampling needle 22 withdraws quantities of the samples from one or more of heater vessels 45 and moves to vessel rack assembly 50. Sampling needle 22 can then be used to dispense metered quantities of samples into vessels 56, 57, and/or 59 at vessel racks 54. At this point, a number of operations can occur at rack assembly 50 that will depend on the specific sample preparation and testing procedure being conducted. As one example, samples could be transferred from rack assembly 50 for further processing by analytical equipment such as a high-pressure liquid chromatography apparatus.

As acknowledged by those skilled in the art, evaporation of the substances contained in heater vessels 45, especially the solvent, is a recurring problem. Solvent evaporation can result in an undesirable change in the concentration of the chemical constituents in each heater vessel 45, thereby impairing the validity of the sampling and analytical processes. Accordingly, heater unit 40 has been conventionally equipped with a fan unit 48, which blows air around the top portions of heater vessels 45 to condense evaporated fluids and particularly the solvent. In this manner, fan unit 48 endeavors to prevent such vapors from escaping heater vessels 45 and causes the vapors to condense onto the walls of heater vessels 45, such that the condensate returns to the bottom portions of heater vessels 45.

This conventional method of blowing room air by the top portions of heater vessels 45, although quite simple to implement, has proven to be quite ineffective. With the use of fan unit 48, heat is transferred from the top portions of heater vessels 45 primarily by the mechanism of forced convection. As a general matter, convection occurs when a fluid such as air flows over a solid body or inside a channel while the temperatures of the fluid and the solid surface are different. Heat transfer between the fluid and the solid surface takes place as a consequence of the motion of the fluid relative to the surface. Without fan unit 48, natural (or free) convective fluid motion would occur as a result of buoyancy forces induced by density gradients in the fluid, which density gradients are the result of temperature gradients directed from the solid surface into the fluid and temperature variations within the fluid itself. Fan unit 48 operates to mechanically induce the fluid motion, which in this case involves forcing the flow of ambient air around the outer surfaces of the top portions of heater vessels 45.

It is well known that forced convection such as by a fan or pump significantly increases the rate of heat transfer as compared with natural convection. However, while the forced convection mode of heat transfer can be quite adequate in other contexts, it is inadequate when applied to an array of vessels such as heater vessels 45. The amount of heat energy added to heater vessels 45 by heater unit 40 and the rate at which such heat energy is added can cause a relatively large quantity of solvent to quickly change into its vaporous phase, such that the forced convection of room air around the top portions of heater vessels 45 does not remove enough heat energy from the top portions to cause the solvent to condense back into liquid phase. As a result, much of the high-temperature evaporated solvent escapes heater vessels 45, even when septa or other sealing components are provided, due to the temperature and pressure differentials between the interiors of heater vessels 45 and the ambient airspace.

Another problem stems from the fact that viscous compounds are often processed in heater vessels 45. It is often required that such compounds be stirred, either constantly or periodically, while being heated. The compounds in heater vessels 45 are often too viscous to be stirred by conventional methods such as by using magnetically driven agitating elements. The problem is exacerbated by the relatively narrow interiors of heater vessels 45 and their close proximity to each other in the vessel array. There is little room around heater vessels 45 for mounting the external magnetic drive assemblies required in the use of magnetic agitation elements. Additionally, there is little room within each individual heater vessel 45 for inserting a paddle or other mechanically driven agitating element in a manner that does not interfere with other components operating within heater vessel 45 such as a sampling cannula.

The present invention is provided to solve these and other problems associated with the processing of substances within vessels.

### DISCLOSURE OF THE INVENTION

Accordingly, the present invention generally provides a compact, fluid-cooled condenser unit constructed from a heat conductive material such as metal. The condenser unit is adapted to fit into the top portion of a sample-containing vessel in order to effectively cool and condense the solvent vapor developed in the vessel and thereby reduce solvent loss from the vessel, all of which is accomplished to a much greater degree than has heretofore been achieved. As will become evident from the description hereinbelow, the condenser unit of the present invention transfers heat from the vessel by presenting several different mechanisms which utilize, to a significant degree, both convection and conduction modes of heat transfer.

The geometry of the condenser unit is such that a variety of surfaces are present within the top portion of the vessel for enabling heat transfer therefrom. In addition, a conduit for the heat transfer fluid is formed as a multi-pass flow arrangement which, in conjunction with the compactness of the condenser unit, increases the overall effectiveness of the condenser unit as a heat exchanger. A large amount of heat energy is carried away from the vessel by circulating a heat transfer fluid such as water through the condenser unit. This circulation keeps the body and surfaces of the condenser unit quite cool, which in turn sets up a variety of complex temperature gradients along several directions from the localized air and solvent vapor in the top portion of the vessel towards the heat transfer fluid circulating within the condenser unit. Significant convective heat transfer occurs at the surfaces of the condenser unit, at the fluid conduit, as well as at the ambient surface of the top portion of the vessel. Significant conductive heat transfer occurs through the body of the condenser unit, as well as across the wall of the vessel.

The present invention also generally provides a stirring unit having a configuration which permits the stirring unit to operate constantly within the vessel without detrimentally affecting other procedures being carried out at the vessel. For instance, the stirring unit can operate at the same time a sampling needle is being employed to dispense or withdraw solvent or sample solution to or from the vessel. The stirring unit includes a mechanically driven paddle which provides sufficient power to stir highly viscous liquids, and it more closely mimics the process used as sample products are “scaled up” as understood by those skilled in the art of pharmaceutical development.

The respective designs of the condenser unit and stirring unit permit each unit to operate together and concurrently within the same vessel. This unique functional combination of paddle stirring and fluid-cooled condensing within the vessel, or within each vessel of a given vessel array, provides a highly useful and effective tool for pharmaceutical development.

According to one embodiment of the present invention, a condenser unit is adapted to condense an evaporative substance in a container. The condenser unit comprises an inner tube, a hollow outer sleeve, and a fluid conduit. The inner tube includes an inner wall with opposing first and second ends. The outer sleeve includes an outer wall coaxially disposed around the inner wall. The outer wall includes opposing first and second ends. The inner tube and the outer sleeve cooperatively define a condenser body and the second end of the inner wall defines an aperture of the condenser body. The fluid conduit is interposed between the inner tube and the outer sleeve, and includes an inlet end and an outlet end. Preferably, the inlet and outlet ends are each disposed proximate to the respective first ends of the inner tube and the outer sleeve. A first portion of the fluid conduit extends along an axial length of the condenser body, and a second portion of the fluid conduit extends along a circumferential length of the condenser body.

According to another embodiment of the present invention, a condenser assembly for preventing evaporation from a container comprises a condenser unit and a heat transfer medium circulation system. The condenser unit has opposing first and second ends. The condenser unit includes an inner tube defining a hollow condenser interior, an outer sleeve coaxially disposed around the inner tube, an inlet aperture, and an outlet aperture. The inner tube and the outer sleeve define a condenser body. A sealing element is attached to the first end and includes a first surface extending radially outwardly beyond the outer sleeve. A fluid conduit is interposed between the inner tube and the outer sleeve, and includes an inlet end and an outlet end. Preferably, the inlet and outlet ends are each disposed proximate to the first end of the condenser body. The inlet end is disposed in fluid communication with the inlet aperture and the outlet end is disposed in fluid communication with the outlet aperture. A first portion of the fluid conduit extends along an axial length of the condenser body, and a second portion of the fluid conduit extends along a circumferential length of the condenser body. The heat transfer medium circulation system is connected to the inlet and outlet apertures.

The condenser assembly is adapted for installation in a container. Such a container includes an open end, a closed end and a hollow container interior. The container can be coaxially disposed around the outer sleeve, such that the open end sealingly contacts the first surface of the sealing element and the second end of the condenser body establishes open communication between the condenser interior and the container interior.

According to yet another embodiment of the present invention, a heat exchange system for transferring heat from a container comprises a condenser body, a header, a heat exchange conduit and a pump. The condenser body has opposing first and second ends, an inner tube defining a hollow condenser interior, and an outer sleeve coaxially disposed around the inner tube. The header is attached to the first end and includes a fluid inlet fitting, a fluid outlet fitting, and a first surface extending radially outwardly beyond the outer sleeve. The heat exchange conduit is interposed between the inner tube and the outer sleeve, and includes an inlet end and an outlet end. The inlet end is disposed in fluid communication with the inlet fitting, and the outlet end is disposed in fluid communication with the outlet fitting. A first portion of the heat exchange conduit extends along an axial length of the condenser body, and a second portion of the heat exchange conduit extends along a circumferential length of the condenser body. The pump is adapted to circulate a heat transfer medium through the heat exchange conduit. The pump includes a pump outlet connected in fluid communication with the inlet fitting through a pump output conduit, and a pump inlet connected in fluid communication with the outlet fitting through a pump input conduit.

According to a further embodiment of the present invention, a condensing and heating assembly is provided for heating fluid contained in a fluid container and preventing evaporation of the fluid from the fluid container. The assembly comprises a heating unit, a mounting frame, and a condenser body. The condenser body has an upper end, a lower end, an inner tube, and an outer sleeve coaxially disposed around the inner tube. A fluid conduit is interposed between the inner tube and the outer sleeve, and includes an inlet end-and an outlet end. A first portion of the fluid conduit extends along an axial length of the condenser body, and a second portion of the fluid conduit extends along a circumferential length of the condenser body. A sealing element is sealed to the upper end and attached to the mounting frame, such that the condenser body is disposed proximate to the heating unit.

According to a still further embodiment of the present invention, a stirrer assembly is provided for stirring a substance contained in a container, and which enables a quantity of the substance to be dispensed into and withdrawn from the container during a stirring operation. The stirrer assembly comprises a stir rod, an agitator element, and a fluid sampling instrument. The stir rod includes opposing first and second open ends and a hollow interior. The hollow interior is situated in open communication with the first and second ends. The agitator element is disposed at the second end of the stir rod. The agitator element includes a tip, a tip aperture, and a hollow interior establishing open communication between the second end of the stir rod and the tip aperture. The stir rod interior and the agitator element interior cooperatively define a stirrer assembly interior. The fluid sampling instrument is movably disposed within the stirrer assembly interior.

According to an additional embodiment of the present invention, a combined condenser/stirrer device is provided for stirring a substance contained in a container, and for condensing evaporative phases of the substance to prevent the evaporative phases from escaping from the container. An inner tube of the device includes an inner wall. The inner wall includes opposing first and second ends and defines a hollow condenser interior. A hollow outer sleeve includes an outer wall coaxially disposed around the inner wall, and includes opposing first and second ends. The inner tube and the outer sleeve cooperatively define a condenser body. A fluid conduit is interposed between the inner tube and the outer sleeve, and includes an inlet end and an outlet end. A first portion of the fluid conduit extends along an axial length of the condenser body, and a second portion of the fluid conduit extends along a circumferential length of the condenser body. A stir rod extends through the condenser interior and beyond the respective second ends of the inner wall and the outer wall.

In another embodiment, the present invention provides a sample preparation assembly comprising a plate, a condenser body, a heat exchange conduit, and a stir rod. The condenser body is attached to the plate and includes an inner tube having an inner wall, a hollow outer sleeve having an outer wall, and a heat exchange conduit. The stir rod extends through an aperture of the plate, through an interior of the condenser, and beyond ends of the inner wall and the outer wall. A drive assembly can be operatively connected to the stir rod and adapted to provide rotational energy to the stir rod. A heat transfer medium circulation system can be placed in communication with inlet and outlet ends of the heat exchange conduit. A heater unit can be disposed proximate to the condenser body.

The present invention also provides a method for preventing the escape of vaporous phases of a substance from a container. A condenser unit is provided in which an outer sleeve is coaxially disposed around an inner tube, and a fluid conduit is interposed between the inner tube and the outer sleeve. A vessel containing a substance is brought into sealed contact with the condenser unit such that the fluid conduit extends into the vessel. A heat transfer medium is circulated through the fluid conduit to cause a vaporous portion of the substance to condense.

The present invention further provides a method for stirring a substance contained in a vessel. A stirring unit is provided which includes a shaft and an agitator element attached to the shaft, such that the shaft and the agitator element include respective hollow interiors cooperatively defining an elongate bore. The stirring unit is inserted into a vessel containing a substance such that the agitator element is immersed in the substance, and the agitator element is caused to rotate. A sampling instrument is inserted through the elongate bore and beyond the agitator element while the agitator element is rotating, such that a quantity of the substance can be dispensed into the vessel or withdrawn from the vessel.

It is therefore an object of the present invention to provide a compact condensing device for use in conjunction with a solution-containing vessel, and which exhibits improved heat transfer characteristics.

It is another object of the present invention to provide a condensing device which enables several significant modes of heat transfer away from the top portion of a vessel.

It is yet another object of the present invention to provide a condensing device which increases the amount of heat transfer surface area within a vessel.

It is a further object of the present invention to provide a condensing device which operates within a vessel while another instrument such as a sampling needle operates within the same vessel.

lt is a still further object of the present invention to provide a condensing device which can be easily integrated into a sample preparation workstation.

It is an additional object of the present invention to provide a mechanically driven stirring unit for use in conjunction with a solution-containing vessel, and which exhibits improved agitating performance.

It is also an object of the present invention to provide a stirring unit which operates within a vessel while another instrument such as a sampling needle operates within the same vessel.

It is another object according to the present invention to provide a stirring unit which can be easily integrated with a condenser unit to form a combined stirring and condensing unit operative within one or more vessels of a sample preparation workstation.

Some of the objects of the invention having been stated hereinabove, other objects will become evident as the description proceeds when taken in connection with the accompanying drawings as best described hereinbelow.

Some of the objects of the invention having been stated hereinabove, other objects will be evident as the description proceeds, when taken in connection with the accompanying drawings as best described hereinbelow.

### BRIEF DESCRIPTION OF THE DRAWINGS

FIG. 1 is a front elevation view of a conventional sample preparation workstation;

FIG. 2 is a perspective view of a condenser unit according to the present invention;

FIG. 2A is a perspective view of the condenser unit illustrated in FIG. 2 with the addition of cooling fins;

FIG. 3 is an exploded view of the condenser unit of FIG. 2;

FIG. 4 is a detailed perspective view of a portion of the condenser unit of FIG. 2;

FIG. 5 is a perspective view of a condenser assembly according to the present invention;

FIG. 6 is a diagram of a heat transfer fluid circulation system according to the present invention;

FIG. 7 is a perspective view of a stirring unit according to the present invention;

FIG. 8 is an exploded view of a stirring assembly according to the present invention;

FIG. 9 is a perspective view of the stirring assembly of FIG. 8 in assembled form;

FIG. 10 is a perspective view of a combined stirring and condensing assembly according to the present invention;

FIG. 11 is another perspective view of the combined stirring and condensing assembly of FIG. 10;

FIG. 12 is a perspective view of the combined stirring and condensing assembly of FIG. 10 installed at a sample preparation workstation in accordance with the present invention; and

FIG. 13 is a perspective view of an alternative embodiment of the combined stirring and condensing assembly of FIG. 10.

### DETAILED DESCRIPTION OF THE INVENTION

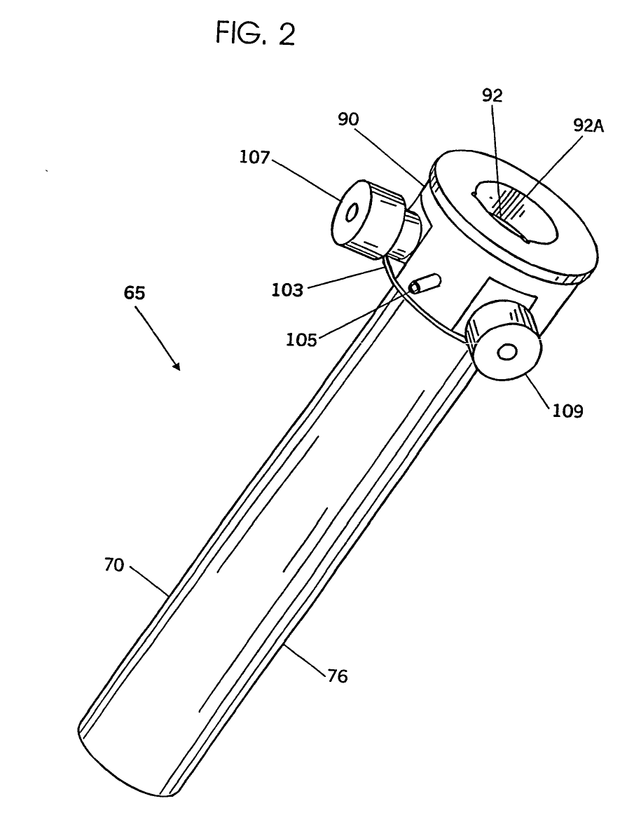

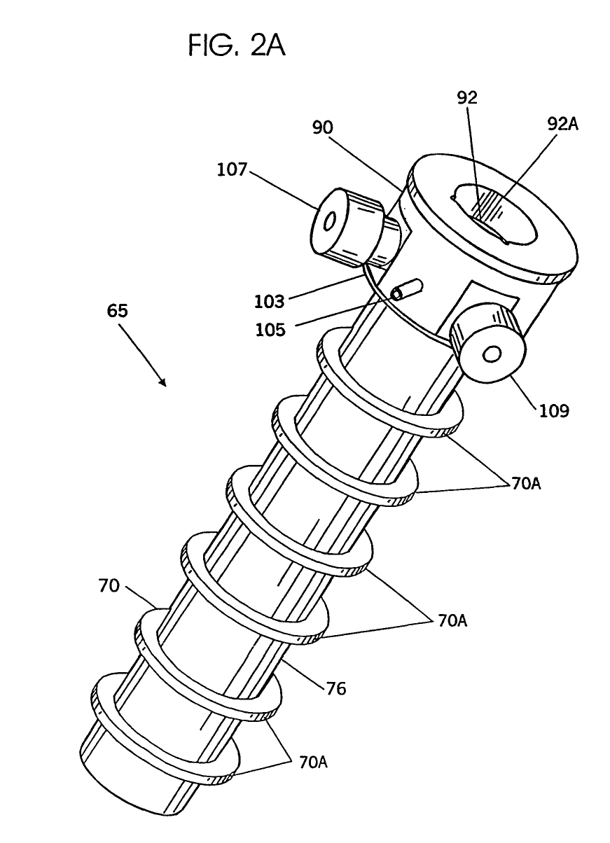

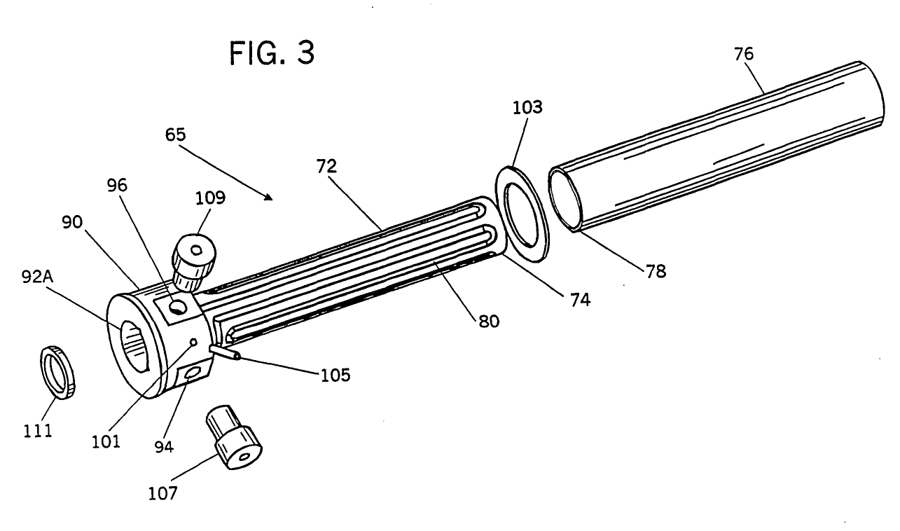

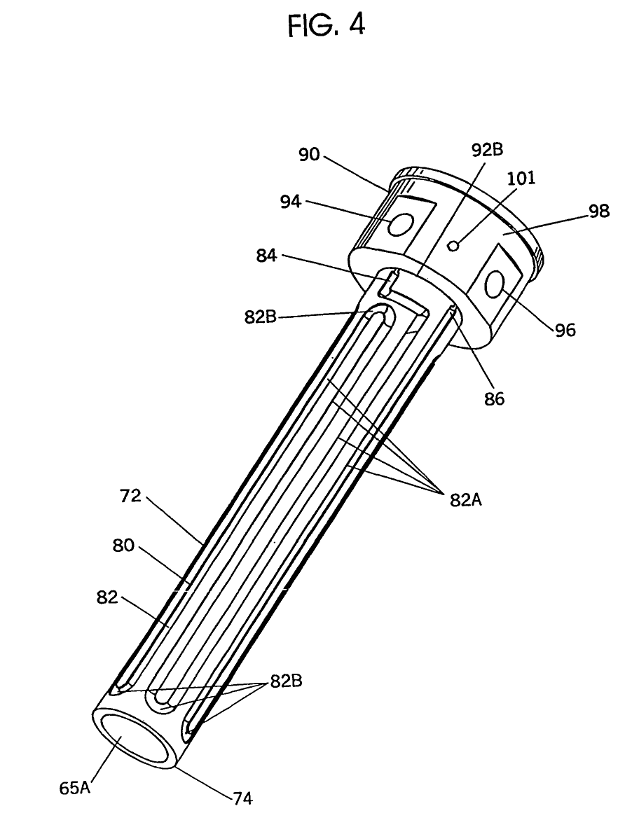

Referring to FIGS. 2-4, a condenser unit generally designated 65 is provided in accordance with one aspect of the present invention. As shown in FIG. 2, condenser unit 65 includes a condenser body 70 and a mounting head 90, each preferably constructed from a good heat conducting material such as steel. As shown in FIG. 3, condenser body 70 includes an inner tube 72 and a coaxial outer sleeve 76. Structurally, inner tube 72 has an inner wall 74 and outer sleeve 76 has an outer wall 78. Referring to FIG. 4, inner wall 74 defines a hollow interior 65A for condenser body 65.

A heat exchange conduit 80 for circulating a heat exchange fluid throughout condenser body 70 (thus serving as a condenser coil) is generally interposed between inner tube 72 and outer sleeve 76. In the preferred embodiment best shown in FIG. 4, heat exchange conduit 80 takes the form of a continuous groove 82 machined into inner wall 74 such that groove 82 and outer wall 78 (see FIG. 3) cooperatively define heat exchange conduit 80. In order to optimize the effectiveness of condenser body 70 as a heat transfer device, the length of groove 82 is maximized. Engineering within the context of the preferred cylindrical structures illustrated, this optimization is implemented by running groove 82 along an alternating serpentine course, such that groove 82 has many axial sections 82A running along the height of condenser body 70 and many transitional sections 82B running generally along circumferential sections of condenser body 70. It can thus be seen that conduit 80 constitutes a multi-pass flow arrangement which increases the overall effectiveness of condensing unit 65 as a heat exchange device.

As best shown in FIG. 4, heat exchange conduit 80 begins at an inlet end 84 and terminates at an outlet end 86. Preferably, both inlet and outlet ends 84 and 86 are located near the top of condenser unit 65, e.g., near mounting head 90, so that external fluid lines do not need to be extended down into the vessel in which condenser unit 65 is to operate.

Referring back to FIG. 2, mounting head 90 has a central bore 92 extending through its axial dimension from a top aperture 92A to a bottom aperture 92B (see FIG. 4). Inlet and outlet apertures 94 and 96 are formed on an outside lateral surface 98 of mounting head 90. Inlet and outlet apertures 94 and 96 are respectively connected in fluid communication with inlet and outlet ends 84 and 86 of heat exchange conduit 80 via internal passages (not shown) within mounting head 90. A vent hole 101 extends radially from outside lateral surface 98 to bore 92. As shown in FIG. 4, inner tube 72 is secured to mounting head 90 at bottom aperture 92B such as by press fitting or micro-welding.

Referring to FIG. 3, condenser unit 65 is assembled by sliding a seal ring 103 over inner tube 72 until seal ring 103 abuts the underside of mounting head 90, and by sliding outer sleeve 76 over inner tube 72. Seal ring 103 is preferably a TEFLON® washer, and serves as a seal for the mouth of a test tube or other vessel into which condenser body 70 is to be inserted. The adjacent ends of inner tube 72 and outer sleeve 76 are micro-welded to ensure that no leaks occur. Using conventional methods, a vent tube 105 is secured at or into vent hole 101, an inlet fitting 107 is secured at or into inlet aperture 94, an outlet fitting 109 is secured at or into outlet aperture 96, and a rotating seal 111 is placed into top aperture 92A of mounting head 90 and situated above vent hole 101. Fittings 107 and 109 and apertures 94 and 96 could be provided, for example, with mating threads for fastening purposes. FIG. 2 illustrates condenser unit 65 in assembled form. Condenser unit 65 is quite compact and, for example, has been successfully installed in a test tube having a main outside diameter of 1 inch which tapers down to 0.7 inch near the top.

In the preferred embodiment, outer sleeve 76 is tightly fit around inner tube 72 in order that heat exchange conduit 80 is tightly sealed. As an alternative, outer sleeve 76 could be radially spaced from inner tube 72 to define an annular chamber (not shown) within which heat exchange conduit 80 could take the form of a small diameter tube running alone a serpentine or helical course.

It is also preferred that heat exchange conduit 80 be singular and continuous. A plurality of heat exchange conduits 80 could be provided for each condenser unit 65, but such an alternative would require additional inlet and outlet fittings 107 and 109 and hence additional complexity.

It can thus be seen that condenser unit 65 can be considered an indirect (or surface) contact-type heat exchanger with multi-pass flow capability.

Referring to FIG. 2A, condenser unit 65 can alternatively be equipped with a set of annular cooling fins 70A disposed around the periphery of condenser body 70. Cooling fins 70A can be provided as separate components attached to condenser body 70, or can be formed by reducing the diameter of several sections of condenser body 70. The addition of cooling fins 70A can result in improved heat transfer characteristics by increasing the overall surface area available for heat transfer, influencing the direction of fluid flow around condenser body 70, and/or promoting turbulence. As understood by those skilled in the art, the geometry, size and spacing of cooling fins 70A must be selected so as to optimize fin efficiency and possibly counteract any resulting increase in thermal or flow resistance.

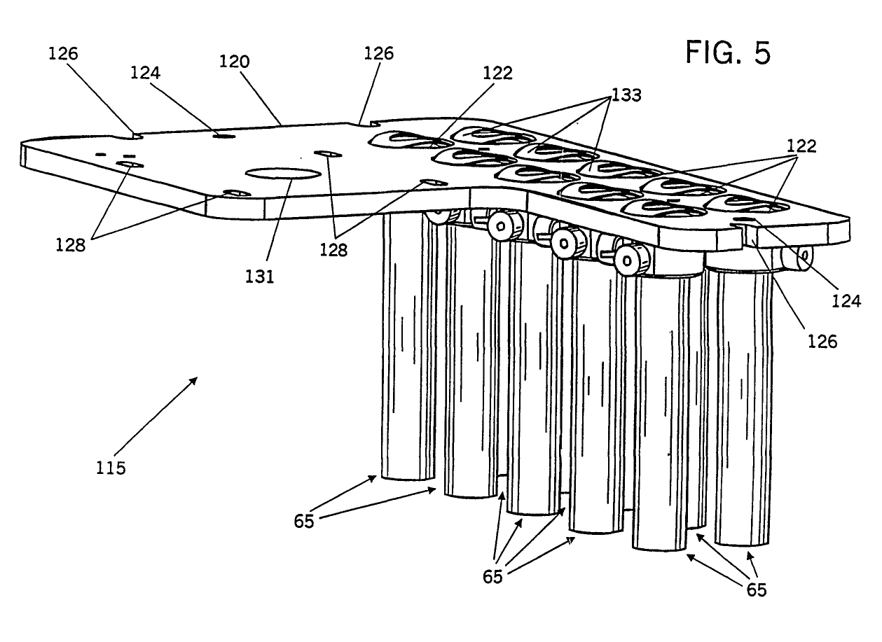

Referring to FIG. 5, a condenser assembly generally designated 115 can be constructed by providing a seal plate 120 to serve as an overhead support for one or more condenser units 65. In the illustrated example, seal plate 120 supports a 2×5 array of ten condenser units 65. Seal plate 120 preferably includes apertures 122 aligned with each mounting head bore 92 (see FIG. 2) as well as seal plate mounting holes 124 and recesses 126. As described in more detail below, seal plate 120 can include motor mounting holes 128, a motor output bore 131, and a plurality of biasing members such as disk springs 133 extending into each seal plate aperture 122. In one example, each condenser unit 65 is supported in its corresponding seal plate aperture 122 by an annular ledge or shoulder (not shown) of seal plate aperture 122 or by a second aperture (not shown) of smaller diameter.

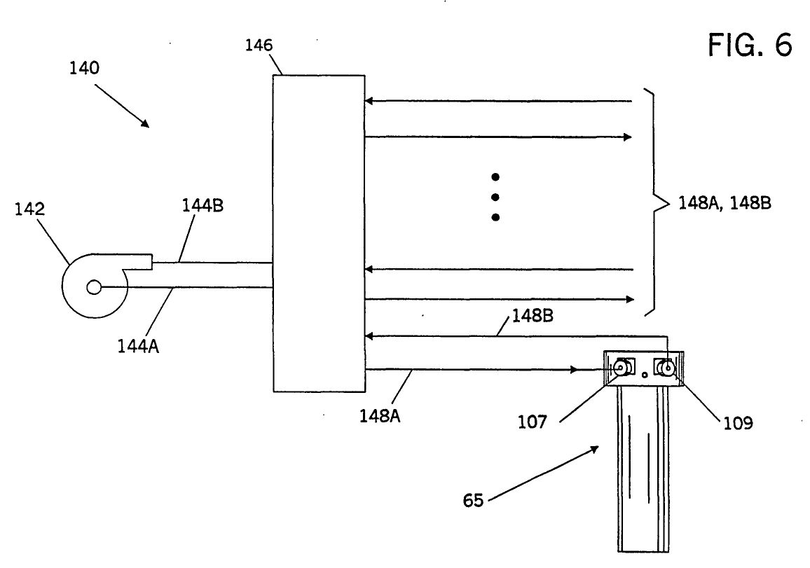

Referring to FIG. 6, a heat transfer fluid circulation system generally designated 140 can be assembled for use in conjunction with one or more condenser units 65. A suitable fluid pump 142 is provided to transfer a fluid heat transfer medium such as water from a source (not shown) over a pair of input and output lines 144A and 144B to and from condenser unit 65. In the case where several condenser units 65 are employed, an accommodation such as a manifold 146 equipped with valves and directional passages as appropriate can interface with individual pairs of input and output lines 148A and 148B associated with each condenser unit 65.

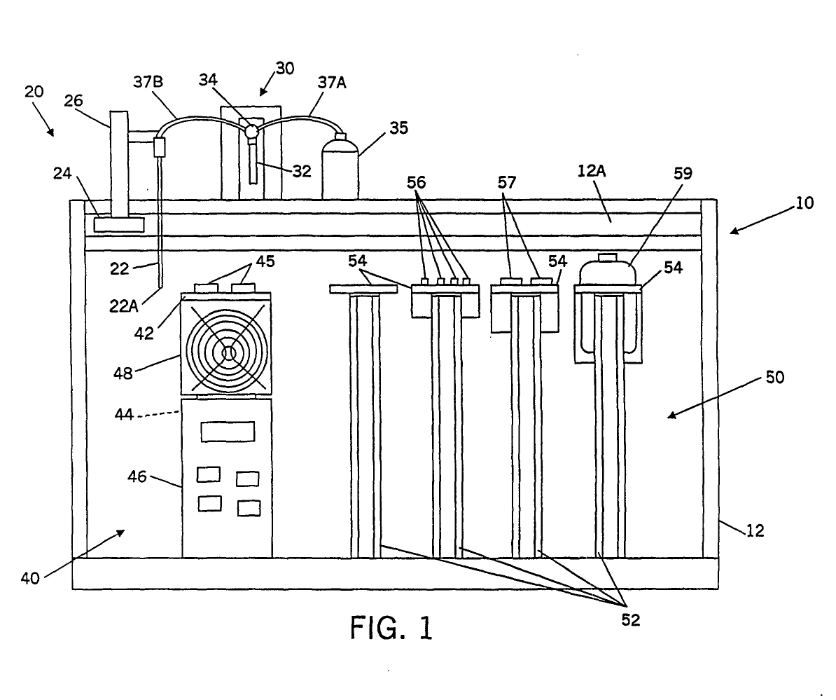

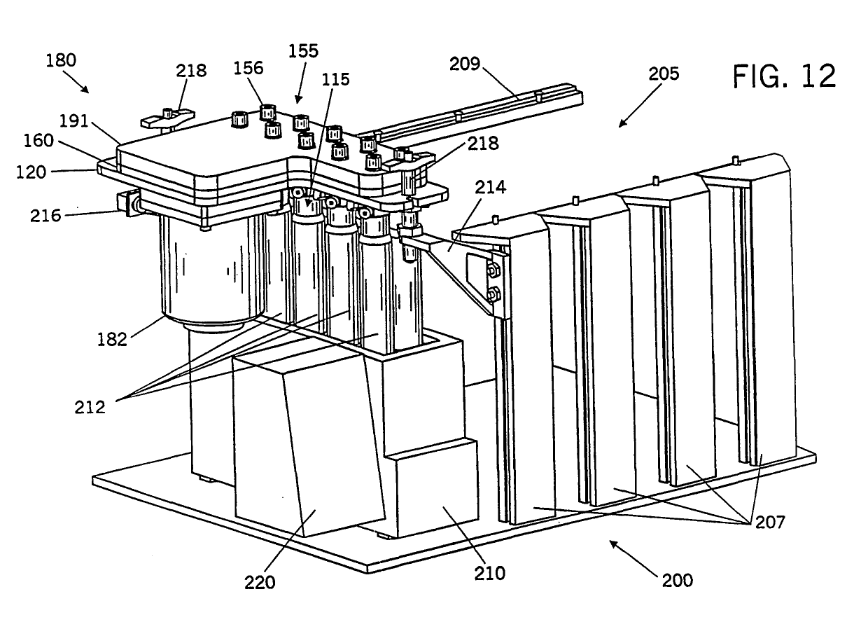

Referring to FIG. 12, the present invention provides a novel sample preparation workstation generally designated 200. Workstation 200 includes a vessel rack assembly generally designated 205 having a framework that includes front rack support members 207 and a rear rack support member 209. Many of the modules typically utilized in conjunction with liquid handling and/or sample preparation equipment, such as those illustrated in FIG. 1, can be integrated with workstation 200 as appropriate for the procedures contemplated by the user. A heater unit 210 is thus provided to heat an array of heater vessels 212. A fan unit (e.g., fan unit 40 in FIG. 1), however, is not required. Instead, improved heat exchanging capability is provided in the form of above-described condenser assembly 115. Accordingly, condenser assembly 115 can be removably mounted to workstation 200 and positioned over heater unit 210 in accordance with the present invention, using suitable mounting components such as mounting brackets 214 and 216 and mounting pins 218 inserted through seal plate mounting holes 122 (see FIG. 5). Seal plate recesses 126 could be utilized to receive removable components (not shown) for transporting condenser assembly 115 to workstation 200 and/or aligning condenser assembly 115 over heater unit 210, or could be used to mount condenser assembly 115 to another location of workstation 200 (such as vessel rack assembly 205) when condenser assembly 115 is in a non-operative standby mode.

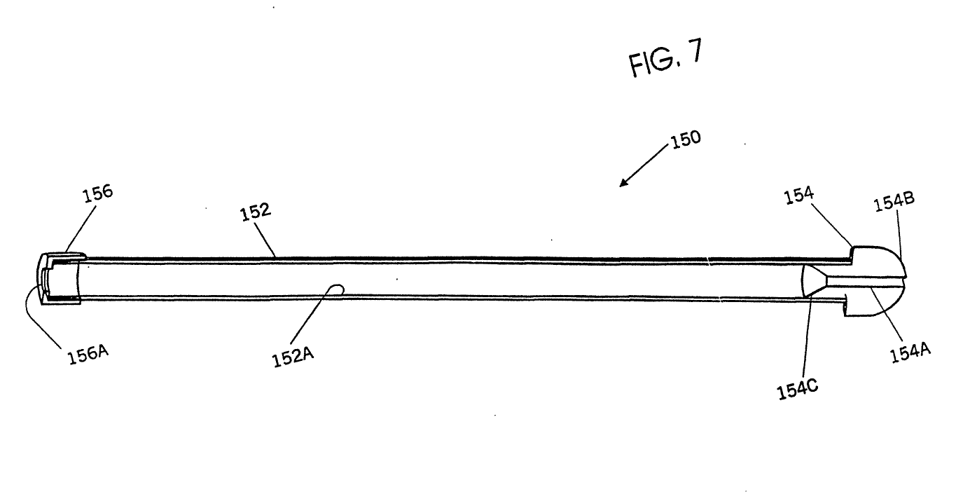

Referring to FIGS. 7-9, a stirring unit in the form of a stir rod generally designated 150 is also provided in accordance with the present invention. Stir rod 150 preferably includes a shaft 152 and an agitator element such as a paddle 154 removably mounted to shaft 152 such as by mated threads. The top of shaft 150 is threaded to receive a plastic cap 156 equipped with a septum 156A. As shown in FIG. 7, in order to permit an instrument (e.g., sampling needle 22 in FIG. 1, a fiber optic probe, or the like) to pass through stir rod 150 into a vessel in which stir rod 150 is to operate, shaft 152 has a bore 152A running along its length, and paddle 154 likewise has a bore 154A extending to its paddle tip 154B. In order to assist the sampling needle in traversing the length of stir rod 150, especially where a robotic liquid handling module (e.g., liquid handling module 20 in FIG. 1) is employed, paddle 154 includes a tapered conic section 154C at the interface between paddle bore 154A and shaft bore 152A.

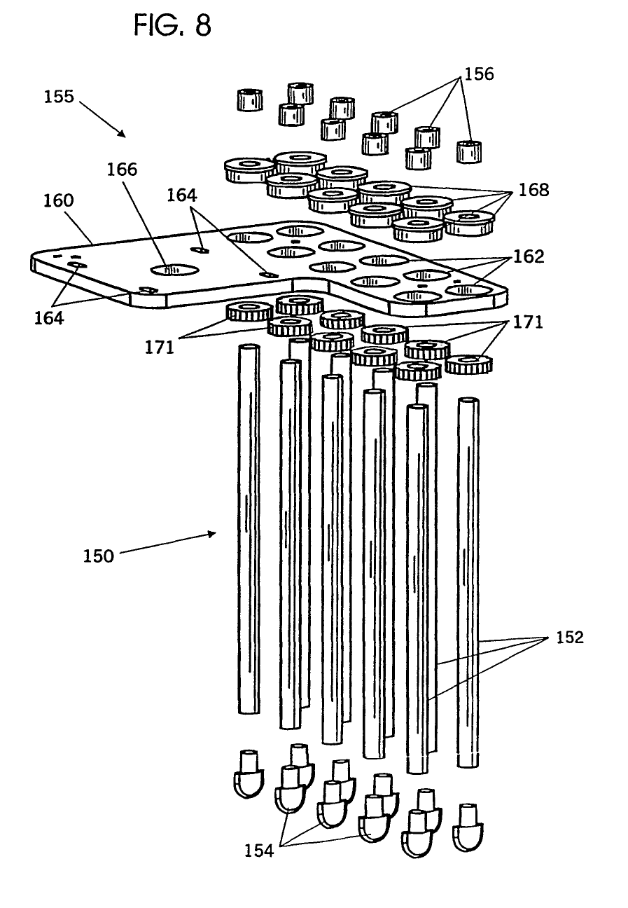

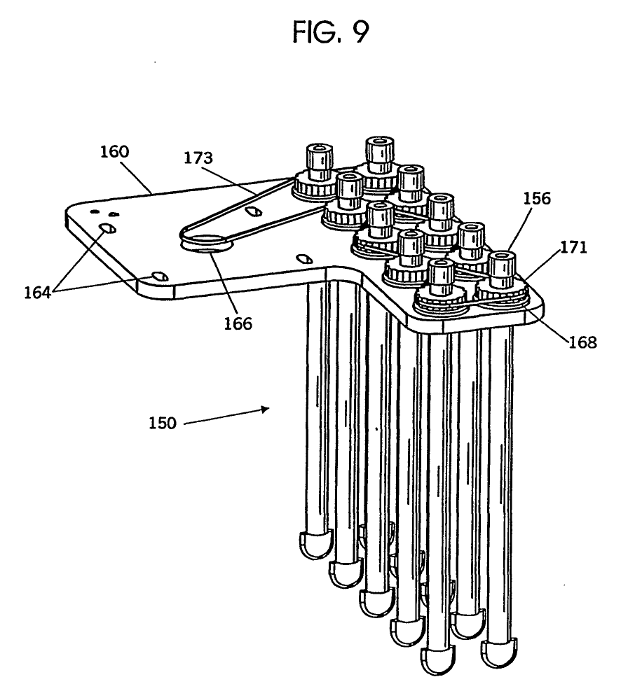

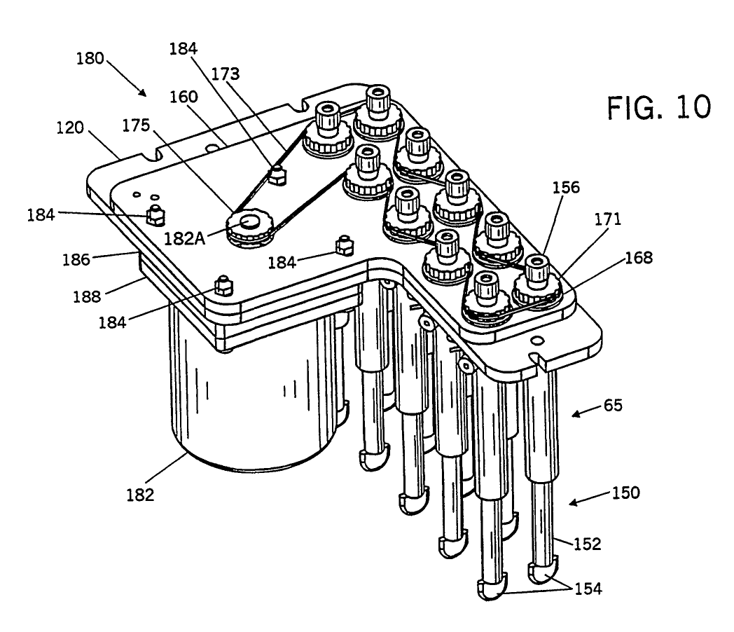

Referring to FIGS. 8 and 9, a stirring assembly generally designated 155 can be constructed by providing a bearing plate 160 and associated bearing and drive components, all of which are adapted to accommodate one or more stir rods 150. In the illustrated example, bearing plate 160 supports a 2×5 array of ten stir rods 150. For this purpose, bearing plate 160 preferably includes apertures 162 through which each corresponding stir rod 150 rotatably extends. Bearing plate 160 can also include motor mounting holes 164 and a motor output bore 166. A roller bearing 168 is disposed in each bearing plate aperture 162 to rotatably support each corresponding stir rod 150. Additionally, a stir rod drive gear 171 is fitted onto each stir rod 150. An endless, flexible drive member such as a polymeric drive chain 173 with double-sided teeth (not specifically shown) is wrapped around drive gears 171 and a motor output gear 175 (see FIG. 10) to provide positive drive capability. If desired, stirring assembly 155 could be operatively mounted to workstation 200 in FIG. 12 apart from condenser assembly 115 to perform agitation procedures.

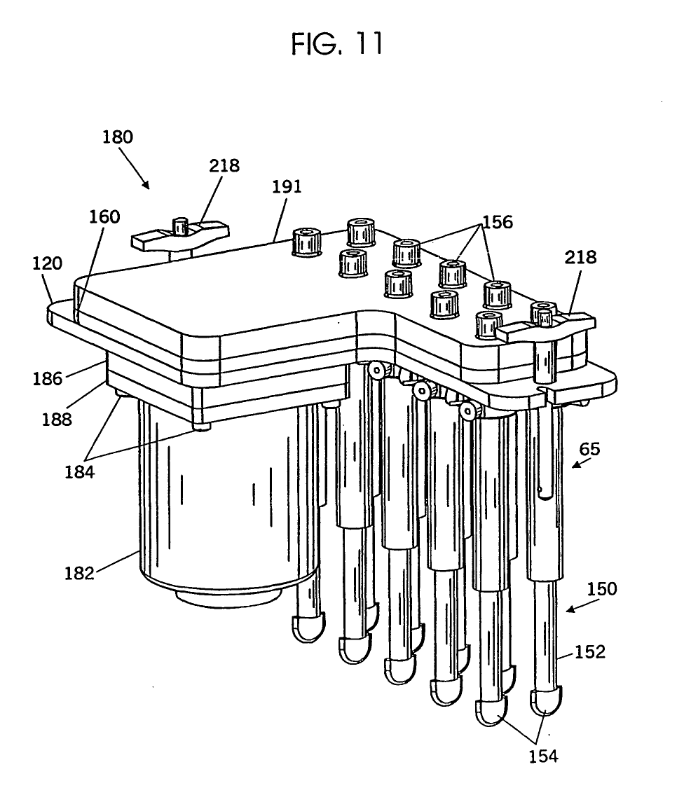

Referring to FIGS. 10 and 11, a preferred embodiment of the present invention combines condenser and stirrer assemblies 115 and 155 into an integrated stirrer/condenser or sample preparation assembly generally designated 180. Bearing plate apertures 162 (see FIG. 8) are aligned with corresponding seal plate apertures 122 (see FIG. 5). Corresponding motor mounting holes 128 and 164 and motor output bores 131 and 166 are also aligned. Shafts 152 of stir rods 150 are inserted through bearing plate apertures 162, seal plate apertures 122, mounting head bore 92 (see FIG. 2) and condenser body interiors 65A (see FIG. 4). Paddles 154 are secured to shafts 152 below condenser units 65. A motor 182 is installed by inserting appropriate fasteners 184 through motor mounting holes 128 and 164, a spacer plate 186, and a motor mounting flange 188. An output shaft 182A for motor 182 extends through output bores 131 and 166, and output gear 175 is fitted thereon. A cover plate 191, shown in FIG. 11, protects the user from the rotating gears 171 and 175.

Referring to FIG. 12, both condenser and stirrer assemblies 115 and 155 (collectively, sample preparation assembly 180) are illustrated in operative position at workstation 200. A paddle speed controller and indicator unit 220 is wired to motor 182. Disk springs 133 (shown in FIG. 5) are interposed between bearing plate 160 and seal plate 120 and held down by bearing plate 160, and act to force seal plate 120 downwardly into improved sealing relation with the mouths of each heater vessel 212. Rotating seals 111 (shown in FIG. 3), positioned in each mounting head bore 92, prevent heated vapors in heater vessels 212 from escaping around stir rods 150 while allowing stir rods 150 to rotate freely. Vent tubes 105 (best shown in FIGS. 2 and 3) prevent an undue amount of pressure from building up inside heater vessels 212 by providing an escape route for vapors, since each vent tube 105 and its associated vent hole 101 are in open communication with corresponding mounting head bore 92, condenser body interior 65A, and the interior of heater vessel 212. It should be noted however that under normal circumstances, the thermodynamic pressure-volume-temperature (P-V-T) relationship characterizing the condensing procedure dictates that no vapors will leak through vent tubes 105. This is because condenser assembly 115 causes such vapors to change back to the liquid phase before the vapors have an opportunity to expand into vent tubes 105.

It should also be noted that some procedures require that reactions occur in heater vessels 212 in the presence of an inert gas such as diatomic nitrogen or argon. In such cases, vent holes 101 can be used as gas inlets for admitting a quantity of inert gas into heater vessels 212, and thus vent tubes 105 can be used as the fittings for these gas inlets. Accordingly, as used herein, the term “vent hole” can be taken to mean “gas inlet” and the term “vent tube” can be taken to mean “gas inlet fitting.”

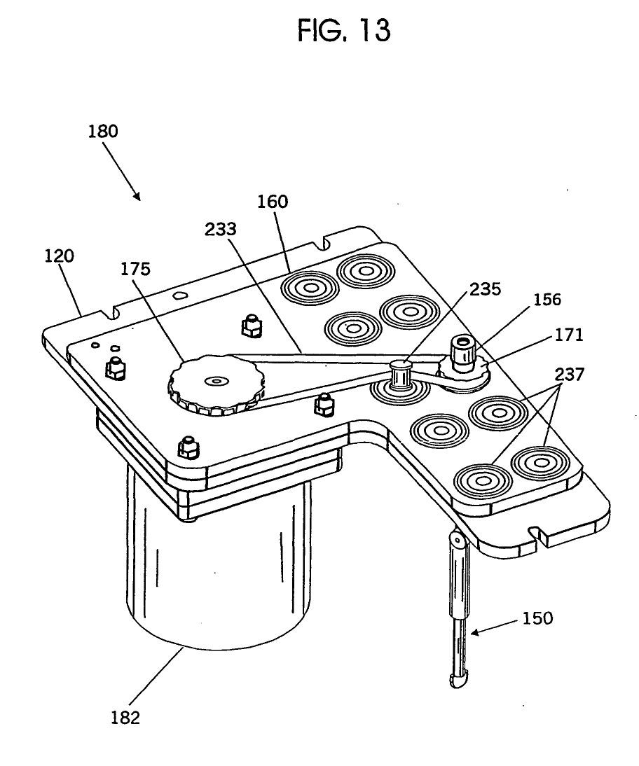

Referring to FIG. 13, sample preparation assembly 180 can be adapted to operate in conjunction with less than a full array of heater vessels 212. In such a case, a drive chain 233 of shorter length can be used and, depending on the number of condenser assemblies 115 and/or stirrer assemblies 155 being used and their positions at bearing plate 160, one or more idler elements 235 can be installed at vacant bearing assembly sites 237.

An exemplary general operation of the embodiments of the present invention will now be described with reference to FIG. 12, with secondary reference made to FIG. 1. The researcher places heater vessels 212 containing masses of drugs or the like into heater unit 210. Stirrer assembly 155, condenser assembly 115 or combined stirrer/condenser assembly 180 is picked up from a standby position and lowered over the array of heater vessels 212. The position of stirrer/condenser assembly 180 is established by inserting mounting pins 218 into mounting brackets 214 and 216. At predetermined time intervals, workstation 200 automatically drives liquid handling module 20 and inserts sampling needle 22 through the septum of each stir rod cap 156, through corresponding stir rod 150 and into corresponding heater vessel 212. Dilution module 30 transfers solvent into each heater vessel 212 to dilute the sampled mass therein to an appropriate volume, thereby producing a sample solution. Fluid flow to each operative condenser unit 65 of condenser assembly 115 is established by heat transfer fluid circulation system 140 (see FIG. 6), motor 182 is switched on to drive each operative paddle 154 of stirrer assembly 155, and heater unit 210 is switched on to heat the sample solutions. Paddle rotation speed can be adjusted by controller and indicator unit 220.

At further predetermined time intervals, liquid handling module 20 can be programmed to insert sampling needle 22 back into each heater vessel 212 so that dilution module 30 can withdraw a metered quantity of heated sample solution from heater vessel 212. Owing to the design of stirring assembly 155, the sample extraction process can occur while paddles 154 are rotating. Liquid handling module 20 can then be used to deliver the sample solution to locations on rack assembly 205 or to a chemical analysis device as called for by the particular procedure.

It can be seen from the foregoing description that the design of each condenser unit 65 of condenser assembly 115, whether or not forming a part of combined stirrer/condenser assembly 180, is a significant improvement over previous condensing approaches. This is due in part to the fact that each condenser unit 65 generates a large amount of both conduction heat flux and convection heat flux away from the top portion of its associated heater vessel 212. For the purpose of the present disclosure, heat flux can generally be defined as the amount of heat energy transferred per unit area per unit time. With respect to conduction, the relevant areas are those surface areas which are normal to the direction of temperature gradients and thus heat flow.

Referring back to FIGS. 2-5, condenser body 70 presents a large amount of surface area through which conductive heat transfer can occur, yet is compact enough to operate within heater vessel 212. In the present case, conduction heat flux is a function of both the thermal conductivity of the material of condenser body 70 and the temperature gradients directed from the outer surfaces of condenser body 70 to the cooler boundaries of conduit 80 within condenser body 70. Owing to the configuration of condenser body 80, temperature gradients are dominant in directions radially inward from the outer surface of outer wall 78 of outer sleeve 76 toward conduit 80, and in directions radially outward from the inner surface of inner wall 74 of inner tube 72. The latter directions are perhaps most significant since most of the evaporative solvent will be traveling upwardly into condenser body interior 65A defined by inner wall 74. Because a heat transfer medium is constantly being circulated through conduit 80, and because conduit 80 extends along a lengthy serpentine course, the entire solid portion of condenser body 70 is kept very cool. This results in large temperature gradients, which become the primary factor contributing to the large conduction heat flux. Because thermal conductivity is a less significant factor, a low-cost, moderately conductive material can be selected for condenser body 70.

Large amounts of convective heat flux are observed at the boundaries between cooled condenser body 70 and the hot evaporative solvent flowing into condenser body interior 65A and along the outer surface of condenser body 70. In addition, the circulation of the heat transfer medium through conduit 80 establishes a strong forced convection which keeps the interfaces between condenser body 70 and conduit 80 cool. In the present case, the convection heat fluxes are a function of the temperature differences between the condenser body surfaces and the vaporous solvent, and between the fluid conduit surfaces and the heat transfer medium. The heat transfer coefficients established at these various boundaries are also a factor. These coefficients depend upon, among other things, the type of fluid flow (i.e., laminar or turbulent) and the geometry of condenser body 70 and conduit 80. The length and shape of condenser body 70 and its corresponding large surface areas, the multi-pass flow arrangement of conduit 80, and the continuous circulation of the heat transfer medium through conduit 80, all result in a large average overall heat transfer coefficient.

Accordingly, the several heat transfer mechanisms established by condenser unit 65 enable a large amount of heat energy to be quickly dissipated from the solvent vapor and subsequently carried away by the heat transfer medium circulating through conduit 80. The solvent vapor, upon striking the surfaces of condenser body 70 at a temperature below the saturation temperature of the solvent during normal pressures, will rapidly condense on those surfaces and be prevented from escaping out of heater vessel 212. It should also be noted that the-condensing function of condenser unit 65 is sufficiently localized within the top portion of heater vessel 212 so as not to impair the heating process performed by heater unit 210 on the sample solution contained in the lower portion of heater vessel 212.

It will be understood that various details of the invention may be changed without departing from the scope of the invention. Furthermore, the foregoing description is for the purpose of illustration only, and not for the purpose of limitation—the invention being defined by the claims.

What is claimed is:

1. A condenser unit adapted to condense an evaporative substance in a container, the condenser unit comprising:
(a) an inner tube including an inner wall, the inner wall including opposing first and second ends;
(b) a hollow outer sleeve including an outer wall coaxially disposed around the inner wall, the outer wall including opposing first and second ends, wherein the inner tube and the outer sleeve cooperatively define a sealed condenser body and the second end of the inner wall defines an aperture of the condenser body; and
(c) a fluid conduit interposed between the inner tube and the outer sleeve and including an inlet end and an outlet end, wherein a first portion of the fluid conduit extends along an axial length of the condenser body and a second portion of the fluid conduit extends along a circumferential length of the condenser body.

2. The condenser unit according to claim 1 wherein the inlet and outlet ends are each disposed proximate to the respective first ends of the inner tube and the outer sleeve.

3. The condenser unit according to claim 1 wherein the respective first ends of the inner and outer walls are sealed together and the respective second ends of the inner and outer walls are sealed together.

4. The condenser unit according to claim 1 wherein the fluid conduit is defined by a groove.

5. The condenser unit according to claim 4 wherein the groove is formed on the inner wall, and the groove and the outer wall cooperatively define the fluid conduit.

6. The condenser unit according to claim 4 wherein the groove is formed on the outer wall, and the groove and the outer wall cooperatively define the fluid conduit.

7. The condenser unit according to claim 1 comprising a mounting head attached to the condenser body proximate to the respective first ends of the inner and outer walls.

8. The condenser unit according to claim 7 comprising a seal plate attached to the mounting head.

9. The condenser unit according to claim 7 comprising an inlet fitting and an outlet fitting, the inlet fitting attached to the mounting head in fluid communication with the inlet end of the fluid conduit and the outlet fitting attached to the mounting head in fluid communication with the outlet end of the fluid conduit.

10. The condenser unit according to claim 7 wherein the inner wall defines an interior of the condenser body and the mounting head includes an interior bore disposed in open communication with the condenser body interior.

11. The condenser unit according to claim 10 wherein the mounting head includes an outside surface and a vent passage disposed in open communication between the outside surface and the interior bore.

12. The condenser unit according to claim 1 comprising a seal plate mounted to the condenser body.

13. The condenser unit according to claim 1 comprising a fin disposed on the condenser body.

14. A condenser assembly for preventing evaporation from a container, the condenser assembly comprising:
(a) a condenser unit having opposing first and second ends and including an inner tube defining a hollow condenser interior, an outer sleeve coaxially disposed around the inner tube, an inlet aperture, and an outlet aperture, the inner tube and the outer sleeve defining a condenser body;
(b) a sealing element attached to the first end and including a first surface extending radially outwardly beyond the outer sleeve;
(c) a fluid conduit interposed between the inner tube and the outer sleeve and including an inlet end and an outlet end, the inlet end disposed in fluid communication with the inlet aperture and the outlet end disposed in fluid communication with the outlet aperture, wherein a first portion of the fluid conduit extends along an axial length of the condenser body and a second portion of the fluid conduit extends along a circumferential length of the condenser body; and
(d) a heat transfer medium circulation system connected to the inlet and outlet apertures.

15. The condenser assembly according to claim 14 comprising a container including an open end, a closed end and a hollow container interior, wherein the container is coaxially disposed around the outer sleeve, the open end sealingly contacts the first surface of the sealing element, and the second end of the condenser body establishes open communication between the condenser interior and the container interior.

16. A heat exchange system for transferring heat from a container comprising:
(a) a condenser body having opposing first and second ends, an inner tube defining a hollow condenser interior, and an outer sleeve coaxially disposed around the inner tube;
(b) a header attached to the first end and including a fluid inlet fitting, a fluid outlet fitting, and a first surface extending radially outwardly beyond the outer sleeve;
(c) a heat exchange conduit interposed between the inner tube and the outer sleeve and including an inlet end and an outlet end, the inlet and outlet ends each disposed proximate to the first end of the condenser body, wherein a first portion of the heat exchange conduit extends along an axial length of the condenser body and a second portion of the heat exchange conduit extends along a circumferential length of the condenser body; and
(d) a pump adapted to circulate a heat transfer medium through the heat exchange conduit, the pump including a pump outlet connected in fluid communication with the inlet fitting through a pump output conduit, and a pump inlet connected in fluid communication with the outlet fitting through a pump input conduit.

17. A heat exchange system for transferring heat from a container comprising:
(a) a condenser body having opposing first and second ends, an inner tube defining a hollow condenser interior, and an outer sleeve coaxially disposed around the inner tube;
(b) a header attached to the first end and including fluid inlet fitting, a fluid outlet fitting, and a first surface extending radially outwardly beyond the outer sleeve;
(c) a heat exchange conduit interposed between the inner tube and the outer sleeve and including an inlet end and an outlet end, the inlet and outlet ends each disposed proximate to the first end of the condenser body, wherein a first portion of the heat exchange conduit extends along an axial length of the condenser body and a second portion of the heat exchange conduit extends along a circumferential length of the condenser body; and
(d) a pump adapted to circulate a heat transfer medium through the heat exchange conduit, the pump including a pump outlet connected in fluid communication with the inlet fitting through a pump output conduit, and a pump inlet connected in fluid communication with the outlet fitting through a pump input conduit.

18. The condensing and heating assembly according to claim 17 wherein a vessel is installed at the heating unit and at least a portion of the fluid conduit extends into the vessel.

19. A stirrer assembly for stirring a substance contained in a container and enabling a quantity of the substance to be dispensed into and withdrawn from the container during a stirring operation, the stirrer assembly comprising:
(a) a stir rod including opposing first and second open ends, and a hollow interior disposed in open communication with the first and second ends;
(b) an agitator element disposed at the second end of the stir rod, the agitator element including a tip, a tip aperture, and a hollow interior establishing open communication between the second end of the stir rod and the tip aperture, wherein the stir rod interior and the agitator element interior cooperatively define a stirrer assembly interior; and
(c) a fluid sampling instrument movably disposed within the stirrer assembly interior.

20. The stirrer assembly according to claim 19 wherein the agitator element is removably mounted to the stir rod.

21. The stirrer assembly according to claim 19 comprising a bearing plate, wherein the stir rod is rotatably mounted through the bearing plate.

22. The stirrer assembly according to claim 19 comprising a fluid handling module, wherein the sampling instrument is movably mounted to the fluid handling module.

23. A condenser/stirrer device for stirring a substance contained in a container and condensing evaporative phases of the substance to prevent the evaporative phases from escaping from the container, the condenser/stirrer device comprising:
(a) an inner tube including an inner wall, the inner wall including opposing first and second ends and defining a hollow condenser interior;
(b) a hollow outer sleeve including an outer wall coaxially disposed around the inner wall, the outer wall including opposing first and second ends, wherein the inner tube and the outer sleeve cooperatively define a condenser body;
(c) a fluid conduit interposed between the inner tube and the outer sleeve and including an inlet end and an outlet end, wherein a first portion of the fluid conduit extends along an axial length of the condenser body and a second portion of the fluid conduit extends along a circumferential length of the condenser body; and
(d) a stir rod extending through the condenser interior and beyond the respective second ends of the inner wall and the outer wall.

24. The device according to claim 23 wherein the stir rod includes a shaft and an agitator element attached to an end of the shaft.

25. The device according to claim 24 wherein the stir rod and the agitator element include respective hollow regions cooperatively defining an elongate bore.

26. The device according to claim 23 wherein the stir rod has an elongate bore.

27. The device according to claim 26 wherein the stir rod includes opposing first and second ends, a septum is mounted to the first stir rod end, and the second stir rod end is disposed below the condenser body.

28. The device according to claim 23 comprising a bearing plate including a bearing plate aperture, wherein the stir rod is rotatably mounted through the bearing plate aperture.

29. The device according to claim 23 comprising a seal plate mounted over the respective first ends of the inner and outer walls.

30. The device according to claim 29 comprising a bearing plate including a bearing plate aperture, wherein the seal plate includes a seal plate aperture and the stir rod extends through the bearing plate aperture and the seal plate aperture.

31. The device according to claim 30 comprising a biasing member, wherein the bearing plate is disposed above the seal plate and the biasing member is interposed between the bearing plate and the seal plate and is adapted to bias the seal plate downwardly.

32. A sample preparation assembly comprising:
(a) a plate including an aperture;
(b) an inner tube including an inner wall, the inner wall including opposing first and second ends and defining a hollow condenser interior;
(c) a hollow outer sleeve including an outer wall coaxially disposed around the inner wall, the outer wall including opposing first and second ends, wherein the inner tube and the outer sleeve cooperatively define a condenser body attached to the plate;
(d) a heat exchange conduit interposed between the inner tube and the outer sleeve and including an inlet end and an outlet end, wherein a first portion of the heat exchange conduit extends along an axial length of the condenser body and a second portion of the heat exchange conduit extends along a circumferential length of the condenser body;
(e) a stir rod extending through the aperture, through the condenser interior and beyond the respective second ends of the inner wall and the outer wall; and
(f) a drive assembly operatively connected to the stir rod and adapted to provide rotational energy to the stir rod.

33. The sample preparation assembly according to claim 32 wherein the plate is mounted to a sample handling workstation.

34. The sample preparation assembly according to claim 32 wherein the stir rod has an elongate bore and a fluid sampling instrument is movable disposed in the elongate bore.

35. The sample preparation assembly according to claim 32 wherein the condenser body includes a seal surface extending radially outwardly from the outer sleeve and a container is coaxially disposed around the outer sleeve, the container having an open end, a closed end and a hollow container interior, and wherein the open end sealingly contacts the seal surface and the condenser interior communicates with the container interior.

36. A sample preparation assembly comprising:
(a) a plate including an aperture;
(b) an inner tube including an inner wall, the inner wall including opposing first and second ends and defining a hollow condenser interior;
(c) a hollow outer sleeve including an outer wall coaxially disposed around the inner wall, the outer wall including opposing first and second ends, wherein the inner tube and the outer sleeve cooperatively define a condenser body attached to the plate;
(d) a heat exchange conduit interposed between the inner tube and the outer sleeve and including an inlet end and an outlet end, wherein a first portion of the heat exchange conduit extends along an axial length of the condenser body and a second portion of the heat exchange conduit extends along a circumferential length of the condenser body;
(e) a stir rod extending through the aperture, through the condenser interior and beyond the respective second ends of the inner wall and the outer wall; and
(f) a heat transfer medium circulation system communicating with the inlet and outlet ends of the heat exchange conduit.

37. A sample preparation assembly comprising:
(a) a plate including an aperture;
(b) an inner tube including an inner wall, the inner wall including opposing first and second ends and defining a hollow condenser interior;
(c) a hollow outer sleeve including an outer wall coaxially disposed around the inner wall, the outer wall including opposing first and second ends, wherein the inner tube and the outer sleeve cooperatively define a condenser body attached to the plate;
(d) a heat exchange conduit interposed between the inner tube and the outer sleeve and including an inlet end and an outlet end, wherein a first portion of the heat exchange conduit extends along an axial length of the condenser body and a second portion of the heat exchange conduit extends along a circumferential length of the condenser body;
(e) a stir rod extending through the aperture, through the condenser interior and beyond the respective second ends of the inner wall and the outer wall; and
(f) a heater unit disposed proximate to the condenser body.

38. A method for preventing the escape of vaporous phases of a substance from a container comprising the steps of:
(a) providing a condenser unit including an inner tube, an outer sleeve coaxially disposed around the inner tube, and a fluid conduit interposed between the inner tube and the outer sleeve, wherein a first portion of the fluid conduit extends along an axial length of the condenser body and a second portion of the fluid conduit extends along a circumferential length of the condenser body;
(b) bringing a vessel containing a substance into sealed contact with the condenser unit such that the fluid conduit extends into the vessel; and
(c) circulating a heat transfer medium through the fluid conduit to cause a vaporous portion of the substance to condense.

39. A method for stirring a substance contained in a vessel comprising the steps of:
(a) providing a stirring unit including a shaft and an agitator element attached to the shaft, wherein the shaft and the agitator element include respective hollow interiors cooperatively defining an elongate bore;
(b) inserting the stirring unit into a vessel containing a substance such that the agitator element is immersed in the substance;
(c) rotating the agitator element; and
(d) inserting a sampling instrument through the elongate bore and beyond the agitator element while the agitator element is rotating such that a quantity of the substance can be dispensed into the vessel or withdrawn from the vessel.
